(19) United States
(12) Patent Application Publication
(10) Pub. No.: US 2026/0348508 A1
(43) Pub. Date: Nov. 5, 2026

(54) METHOD AND APPARATUS FOR HIGH TEMPERATURE, HIGH SPEED PROCESSING OF VITREOUS-CERAMIC COATINGS ON STEEL

(71) Applicant: AmpClad Coating Technologies Inc., Edmonton (CA)

(72) Inventors: Shaun Kjosness, Sherwood Park (CA); Ryane Fedoruk, Sherwood Park (CA); Jeff Cochrane, Leduc (CA); Glenn N. Pfendt, Florence, KY (US); David Grant Lingnau, Calgary (CA)

(21) Appl. No.: 19/488,830

(22) PCT Filed: May 24, 2024
(86) PCT No.: PCT/CA2024/050698

§ 371 Date: Dec. 1, 2025

Related U.S. Application Data
(60) Provisional application No. 63/470,126, filed on May 31, 2023.

(51) Int. Cl. F16L 58/14; C23D 5/02

(52) U.S. Cl. CPC F16L 58/14; C23D 5/02

(57) ABSTRACT

The present innovation employs specially designed heat schedules and an apparatus to simultaneously optimize properties of both vitreous-ceramic coating and metal substrate in one integrated, temperature-controlled process. Vitreous-ceramic coatings are fired at a higher than standard temperature range to take advantage of common steel processing temperatures to achieve desired metallurgical properties. It can be applied to straight or curved pipe of varying diameter and wall thickness. During the firing process and maturation of the high-performance vitreous-ceramic coating, specified steel tensile and Charpy toughness requirements are achieved through a single heat schedule and optional, optimally controlled quench process. Vitreous-ceramic coatings are modified to take advantage of the much higher steel temperature schedules and steel heat and quench times are typically shortened to achieve or maintain desired physical properties. Induction heating methods are required to achieve the required heat rates and much higher than typical temperatures while various quench cooling methods are used.

### TECHNICAL FIELD

The present disclosure generally relates to performing a vitreous-ceramic coating on a metal substrate. More particularly, the disclosure relates to a method and apparatus using specially designed heat schedules to simultaneously optimize properties of both the vitreous-ceramic coating and the metal substrate in one integrated, temperature-controlled process.

### BACKGROUND

For many important applications, steels undergo controlled individual heat treating and quenching processes to achieve a specific microstructure which imparts desired physical metallurgical properties like high tensile strength and toughness. Pipeline steels are a prime example of how the chemistry and steelmaking processes have co-developed in recent decades to produce pipe which has outstanding performance in terms of physical properties. Purity, strength, toughness and weldability have all been concurrently maximized far beyond what existed 50 years ago, in many cases with properties several times better than that era. Amazingly, these improvements have not required significant additions of expensive alloying elements such as chrome, nickel, molybdenum, etc. Instead, improved properties have primarily been achieved by cleaner steelmaking processes which remove almost all the undesirable elements (sulfur, phosphorus, oxygen, etc.) together with integrated control of rolling process and temperature. Often these high performance steels are classified as Thermo-Mechanically Controlled Process steels, abbreviated to “TMCP”. There are further subsets such as microalloyed steels which add miniscule amounts of nano-carbide forming elements such as niobium, vanadium, titanium, etc. With all of these performance improvements, there is still one important thing missing—corrosion resistance. For many years the pipeline industry has relied on either organic polymer coatings or corrosion resistant alloys (stainless steels) which are extremely expensive and increasing in price due to competing demand from the burgeoning electric automobile industry. Organic polymer coatings have serious limitations with adhesion, disbondment, temperature, moisture permeability to name a few. Looking ahead to the advent of the hydrogen economy, there is one other problem with polymer coatings—they are all permeable to hydrogen.

By contrast, vitreous-ceramic coatings form true chemical bonds with the steel instead of just mechanical bonding and have far higher service temperatures, immunity to disbondment and are many orders of magnitude less permeable to even the tiny hydrogen molecule. In other words, vitreous-ceramic coatings look like the perfect coating for modern high-performance steels in pipelines. However, there is one way in which the two appear to be incompatible. Typical firing temperatures for vitreous-ceramic coatings on steel are in the range of 800 °C to 900 °C. This is well above the critical transformation temperature of steel, A1 which, depending on exact composition, is around 725 °C to 775 °C. At these firing temperatures, the wonderful mechanical properties of modern steels would be so severely degraded that all but the lowest strength classifications would fail to meet regulatory specifications for yield strength and probably also fail the toughness requirements. Hence the need for the present invention. Vitreous-ceramic coatings typically have curing or firing temperatures optimum to the development of bond and properties such as corrosion resistance or control of hydrogen permeability. Long conventional natural gas furnaces used for coatings require long firing times which subjects steel to excessive oxidation or hydrogen absorption. When metal objects like steel pipes are manufactured, they are very often reheated and quenched during tempering or stress relieving, reheated again when shaping the metal object or when curing or fusion bonding a vitreous-ceramic coating. These temperature schedule processes interfere and often limit each other: sacrificing steel physical properties to bond the vitreous-ceramic coating or compromising coating properties to maintain those of the substrate. Multiple heat cycles also increase costs and handling time.

Processing a metal object, as in this example a steel pipe, at elevated temperatures in such a way as to bond a high-performance vitreous-ceramic coating to the inside poses several challenges. The most common challenge is the significant loss of steel mechanical properties overcome by methods set forth herein. Conventional vitreous-ceramic coating firing, typically in natural gas fired furnaces, is predominantly radiative heat transfer resulting in slow heating rates of the pipe until temperatures are reached to mature or fire or cure the vitreous-ceramic coating and facilitate the bonding of the coating to the steel. A ware temperature of 843 °C (1550 °F) normally used in conventional gas fired furnaces often requires extended heating time for larger pieces. To fire an internally applied vitreous-ceramic coating on a steel pipe 40 feet long, ranging from ¼ inch to several inches thick, multiple hours in an extremely large furnace would be required to properly mature the vitreous-ceramic coating within. A temperature schedule like the one described generally results in considerable loss of metallurgical physical properties of the steel including tensile strength and Charpy impact toughness. Additionally, the pipe may warp drastically and absorb undesirable components of the furnace atmosphere; oxygen will oxidize the steel and hydrogen will be formed from decomposed water vapor or products of combustion. Both gases can have highly detrimental consequences on coating and steel performance properties.

These challenges are overcome by taking advantage of induction and or Joule effect heating of the pipe which is much more rapid and high temperature capable and can be controlled in localized areas or adjusted for different steel cross sectional thicknesses or end of pipe areas. Rapid heating can also control and limit exposure time and thus limit the undesirable levels of oxide development at the vitreous-ceramic coating steel interface. This also greatly limits the absorption of undesirable gases by the steel such as hydrogen which is very soluble in steels at elevated temperatures. Induction heating also allows much higher temperatures than conventional furnaces and thus more flexibility with the right temperature schedule to achieve excellent properties of both substrate and coating. Rotary conveyance processing prevents bowing or flattening and allows for even heat distribution. The controlled rapid heating and subsequent controlled cooling or quenching schedule can be used to control physical properties of the steel. Most firing of vitreous-ceramic coatings to steel results in the loss of mechanical properties of the metal. Because of this, expensive higher strength steel alloys or more expensive pipes of greater wall thickness are needed to compensate when coatings are conventionally applied. Those conventional approaches are still faced with undesirable absorption of hydrogen and oxygen and possible warping and handling problems of full-length, hot pipes.

One reason for traditional thermal processing causing loss of metallurgical properties of steel pipe is the alpha to gamma phase change upon heat up and reversal upon cooling. This body centered cubic to face centered cubic steel transformation can also impact coating performance. Staying below that transformation temperature, around 725 °C (1340 °F) for very low carbon steels, higher temperatures for high carbon steels, to maintain steel strength significantly limits coating performance, adherence and corrosion properties while greatly increasing coating costs. Going above that transition temperature to properly fire out and bond the coating can result in loss of steel physical properties when cooled depending on rate of temperature increase, time above transition temperature and rate of cooling.

In prior art some past developments get around some of these challenges by limiting even the induction firing temperatures of vitreous-ceramic coating and limiting steel to thin gauges, like those used on mufflers for example. In prior art the localized rapid induction heating on thin metal parts such as mufflers does help control warpage and hydrogen absorption however, the vitreous-ceramic coating is applied very thin typically from 0.5 mil (13 microns) to about 4 mils (100 microns), in coating fired thickness. The results will give nice color to the surface, inhibit rusting from weathering on a muffler, and the coating survives the muffler temperatures. However, the muffler application does not require nor achieve the use of thick, high-strength steel specifications nor is there the coating requirement for high levels of adherence and long-term corrosion protection. Lower temperature coating applications do not control or greatly limit hydrogen permeability. All the described higher performance levels require a much higher coating thickness in the 6 mils (150 microns), up to about 60 mils (1525 microns). High performance vitreous-ceramic coating corrosion protection generally occurs in the range of 12 mils to 24 mils which are applied to much thicker steels commonly in the range of ¼ inch to 2 inches. Therefore, there is opportunity to improve processes and apparatuses to perform vitreous-ceramic coating on metal substrates.

### SUMMARY

What is demonstrated is an ability to change and control the heat up and quench rates to achieve and optimize both steel physical properties and vitreous-ceramic coating bond. This may be performed on steel pipes of high thicknesses ¼ inch to 4 inches and high coating thicknesses from 5 mils to 60 mils. This approach also supports high coating performance properties achieved by elevated coating firing temperatures. General practice limits coating to low firing temperature under 900 °C (1650 °F) or even lower typical firing temperatures around 843 °C (1550 °F). This novel approach allows high firing temperatures over 900 °C (1650 °F) and often to temperatures as high as 1100 °C (2010 °F) thus enabling exceptionally high temperature, very high performing coatings, resulting in shorter processing time and strong steels.

The invention includes multiple non-limiting embodiments where high-performance coating of a modified vitreous-ceramic composite can be adapted for a range of processing and lifespan requirements. It can be applied via spray as a wet slurry, in dry powder form, or a fractional combination of states and layers. Another advantage is that it can be applied as a single layer as it does not require a pre-coat to form a chemical bond. Multiple layers of the novel modified vitreous-ceramic coating can be utilized to achieve different goals. For example, a specialized base layer can be used to account for and counteract the dynamic thermal expansion coefficient of steel during cooling, whereas the top layer would maximize the overall lifetime of the coating. Higher temperature ranges associated with steel processing not only allow the coating to fire and mature faster, but also allow for rapid migration of gases for degasification. In turn, this creates a bubble structure in the vitreous-ceramic coating which enhances structure and mechanical durability.

This invention controls both the mechanical properties of the substrate and optimizes the desired performance properties of the coating. This invention also achieves control independent of the method by which the coating is applied to the pipe. Novel approaches as described enable the highest performance of the entire system of substrate properties, steel in this example, and properties of vitreous-ceramic coating, while permitting the use of many types and thicknesses of both coatings and metal/alloy substrates. Heating to control steel normalizing is readily done as this vitreous-ceramic coating is fired and bonded on the steel but this method describes significant adjustment of times and temperatures necessary to control both operations. This control results in achieving optimized properties of both the steel substrate and the coating and further can do so when combined in essentially one thermal process step. Processing is achieved while minimizing the negatives of warpage, over oxidation of the steel coating interface, and control to limit the major negatives of hydrogen absorption of the steel that commonly occurs during conventional processing. This approach greatly broadens the coating types that can be used, the thickness of coating application, allows higher temperature coating and thus the types of properties of coatings and methods of coating applications that are possible. This method allows steel performance standards, like ASTM, CSA, and API, to still be met. Thus, the heat schedule can combine the initial steel normalizing and coating heat treatments around 925±25 °C while controlling steel microstructure and quench treatments all on the same line. This ultimately eliminates pipe handling and lost time through integration of required steps on one production line.

In a non-limiting embodiment, the invention includes a method of thermal processing, curing or firing a vitreous-ceramic coating on a metal object to develop desired coating and metallurgical properties in such a way as to achieve them both in one process of short duration. The interface of the substrate and vitreous-ceramic coatings herein are rapidly heated via induction to temperatures that meet or greatly exceed 890 °C (1630 °F) for the coating firing or curing schedules used, and in most processing applications up to 1100 °C (2010 °F).

The method can further include where the induction and/or Joule effect heating is controlled in a time and temperature thermal schedule using a range of frequencies, power inputs, induction coil substrate proximities, coil shapes, number of coils and moving of coils and/or moving metal object at controlled rate to and/or rotation to develop target properties of both the coating and metal substrate to give the desired properties of each on the places of the metal object where desired adjusted to accommodate the thickness and shape of metal substrates.

The method can further include cooling or quenching using water or other liquids sprayed or applied or gasses including but not limited to air, air and water mists, liquid CO2, oils, liquid nitrogen, or cryogenics each individually or in combination to chill or quench the metal and coating at the desired rate, depth, and location on the metal object. Quenching can occur after heating through thickness or simultaneous back side cooling and front side heating to control transformation depth.

The method can further include where the coating is applied to interior and/or exterior of metal objects such as steel pipes or fittings or couplings or shapes such as elbows or manifolds and then heat processed and/or quenched or simultaneous application while heat processing and or quenching.

The method can further include where coating application can be done by a variety of methods including: wet spray or dry spray or flow coat or electrostatic spray or fill and drain or electrophoretic deposition or plasma spray or flame spray or in hot or cold application or in combination of various application methods.

The method can further include where multiple coatings or layers of a coating are applied and fired individually, in combination, or all at one time to produce functionally gradient coatings such as but not limited to a bonding layer and or ground coat first and subsequent layers to develop desired properties such as but not limited to corrosion resistance, abrasion resistance, thermal shock resistance, control of coefficient of thermal expansion and/or to control or limit hydrogen permeability.

The method can further include where metallurgical properties to be controlled are but not limited to control of tensile, Charpy, and hardness but can include control of microstructure, grain size and amounts of phases present while also controlling coating microstructure, bubble structure and refractory or metal powder aggregates therein.

The method can further include where coating properties to be controlled by thermal processing are but not limited to control of hydrogen permeability, adherence, acid or base or water or saltwater corrosion resistance, abrasion resistance, temperature resistance, pressure resistance, undercut corrosion, coefficient of expansion, and surface coefficient of friction while heat treating and thermal processing the metal substrate.

The method can further include where process steps can be performed separately and/or closely sequential and/or simultaneous on both the steel and coating. This includes coating application processes, induction or Joule heating, normalizing, and controlled cooling or quenching. Preferred method is one thermal process step to develop desired properties for both metal substrate and coating.

The method can further include where the resulting vitreous-ceramic composite coating is virtually impermeable to hydrogen as well as corrosion resistant to other organic gases such as methane as well as liquids such as crude oils or the distillation products therefrom or water or salt solutions not containing fluorides.

The method can further include where green pipe direct from the pipe manufacturer uses the method described herein as one heating schedule to normalize the full-thickness of green pipe and fire on to fully mature the vitreous-ceramic coating and use a heating and quench schedule that also maintain firing schedule that will fully mature or fire bonding on the coating while normalizing the green pipe and heating and/or quenching to establish or maintain the metallurgical properties required in a single integrated thermal cycle.

The method can further include where encapsulant additive and/or an encapsulated powder version of the vitreous-ceramic coating is applied electrostatically via spray lance located anywhere from proximity to 36 inches away from the heated zone for adhesion prior to firing. Singular or multiple lance heads may be used and cooled with air, liquid, or any combination of coolants. Additives may be combined with the powder to enhance properties such as bubble structure or fired thickness, for example, to match or exceed coating properties applied non-electrostatically.

The method can further include where the heating and or quenching schedule can be controlled by induction frequency ranging from 1 kilohertz to 100 kilohertz.

These, as well as other components, steps, features, objectives, benefits, and advantages, will now become clear from a review of the following detailed description of illustrative embodiments, the accompanying drawings, and the claims.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is chart showing general temperature in relation to time in a ceramic coating process of steel;

FIG. 2 is a chart showing temperature in relation to time in a pre-ceramic coating process of steel;

FIG. 3 is a flowchart of a pre-process wet slurry coating and induction bonding;

FIG. 4 is a chart showing temperature in relation to time in a post-ceramic coating process of steel;

FIG. 5 is a flowchart of a post-process wet slurry coating and induction bonding;

FIG. 6 is a flowchart of a dry process electrostatic coating and induction bonding;

FIG. 7 is a chart showing temperature in relation to time in a ceramic coating process of steel using a fluidized bed example;

FIG. 8 is a flowchart of a dry process electrostatic coating and induction bonding;

FIG. 9 is a chart showing temperature in relation to time in a ceramic coating process of steel in a non-limiting embodiment;

FIG. 10 is a schematic-type drawing of a ceramic coating apparatus;

FIG. 11 is a schematic-type drawing of a ceramic coating apparatus of a second non-limiting embodiment;

FIG. 12 is a schematic-type drawing of a ceramic coating apparatus of a third non-limiting embodiment; and

FIG. 13 is a chart showing temperature in relation to position for external heating and internal cooling in a ceramic coating process of steel.

For the purposes of promoting an understanding of the principles of the embodiments, reference will now be made to the embodiments illustrated in the drawings and specific language will be used to describe the same. It will nevertheless be understood that no limitation of the scope of the embodiments is thereby intended. Any alterations and further modifications in the described embodiments, and any further applications of the principles of the embodiments as described herein are contemplated as would normally occur to one skilled in the art to which the embodiment relates.

### DETAILED DESCRIPTION

The present disclosure relates to a method and apparatus using specially designed heat schedules to simultaneously optimize properties of both the vitreous-ceramic coating and the metal substrate in one integrated, temperature-controlled process.

### Temperature-Time Controls

Referring to FIG. 1, in ceramic coating process of steel, temperature of the steel is increased at a constant rate above the austenitic transformation temperature, A1 (typically 720±20 °C [1330±70 °F]), and into the target firing range (001), of 890 °C to 1100 °C [1630 °F to 2010 °F] at time t₁. Maximum temperature will vary for conveyance speed and/or time held at temperature. The shaded area under the temperature-time plot and bounded by the minimum firing temperature between approximate times t₁ and t₂, (002), is defined as the heat work. This heat work is required for proper firing of the ceramic coating and can be kept constant by adjusting maximum firing temperature and firing time such that the bounded area remains similar. At time t₃, the piece has been fully fired and is just above the transformation temperature, A1, of the steel; a linear timescale (003) was used until this point in time. Depending on the rate of cooling applied at t₃, different phases and microstructures can be formed. Three paths depicting common cooling rates are shown in logarithmic time (004). Rate 1 (005) corresponds to rapid cooling from an aggressive quench which forms a hard, martensitic structure. Additional heat treatment below the transformation temperature of the steel and firing temperature of the ceramic coating may be required to relieve stresses and temper the martensite. Rate 2 (006) is a mild quench, such as with forced air or a low flow rate of water or other fluids, and results in a primarily lower bainitic microstructure with potential for partial martensite phase formation. Rate 3 (007) corresponds to normalizing in still air and will often form a microstructure containing pearlite and/or bainite. Method of coating will be chosen based on part geometry and rate of cooling will be chosen based on mechanical property requirements and elemental composition.

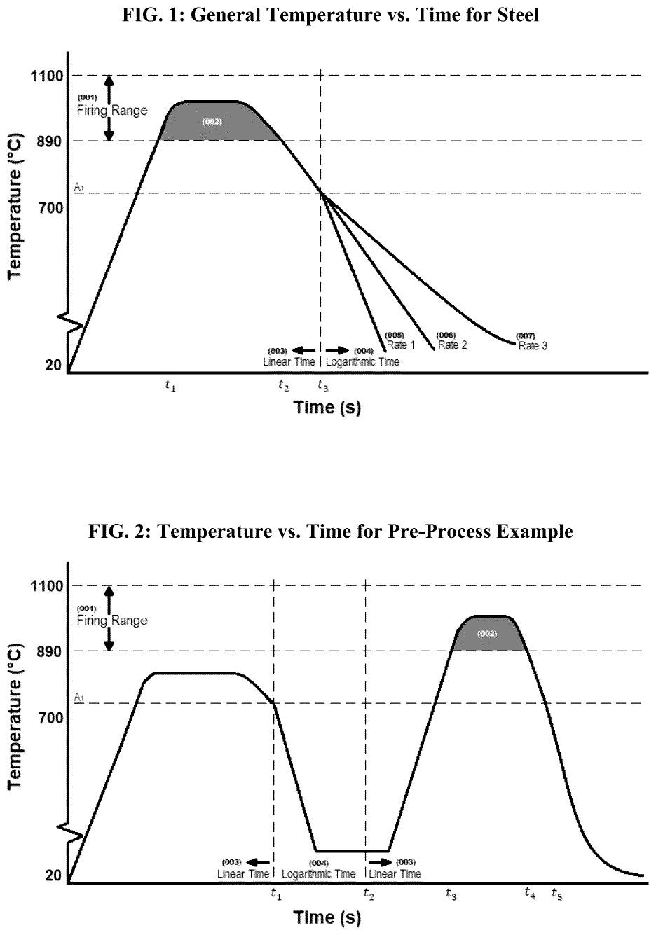

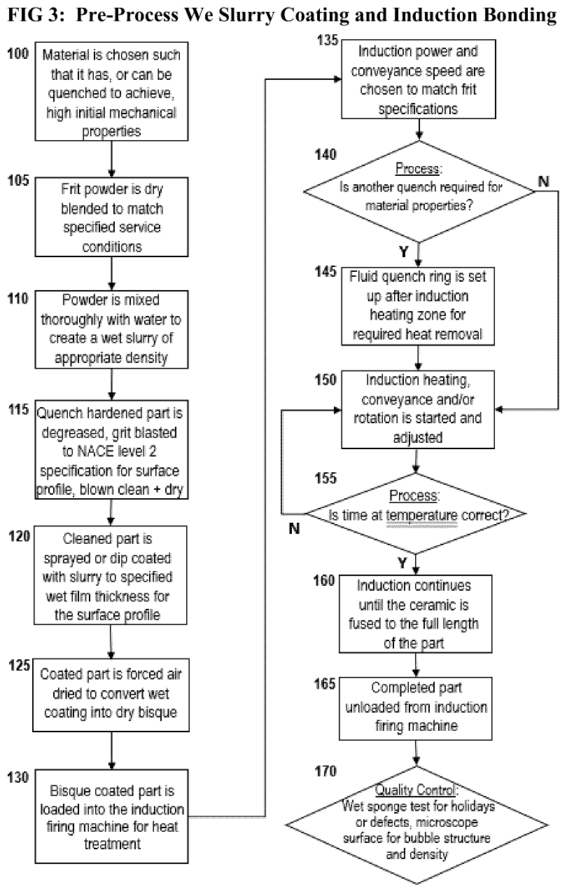

Referring to FIGS. 2 and 3, a temperature-time of a heat schedule for pre-process induction bonding will be described in relation to processing steps. For this example, a seamed, electric resistance welded (ERW) pipe is initially heated and held above the austenitic transformation temperature, A1. The pipe is aggressively quench hardened with a high volume of water at time t₁ (logarithmic time scale (004)). After the quench, the pipe is grit blasted and internally coated. Normalizing is then performed to relieve internal stress from the pipe and homogenize the microstructure above the upper critical temperature; this step begins after time t₂ (linear time scale (003)) and coincides within the firing range (001) of the ceramic coating between times t₃ and t₄. Heat work (002) is depicted as the shaded region under the graph (referring to FIG. 2). Typically, the pipe would cool in still air after t₅, but alternative quench methods may be used at this time if necessary for target microstructure or mechanical properties.

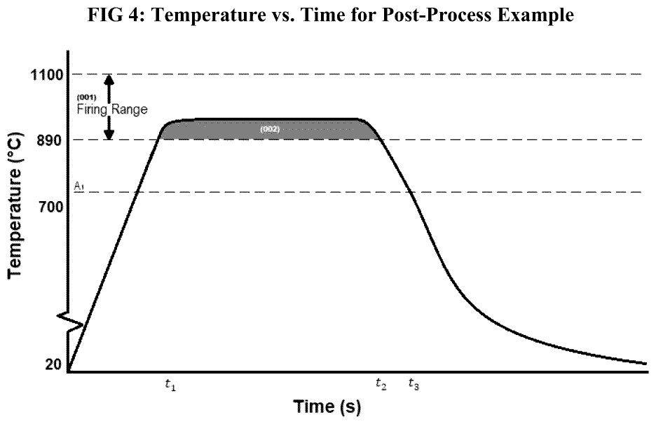

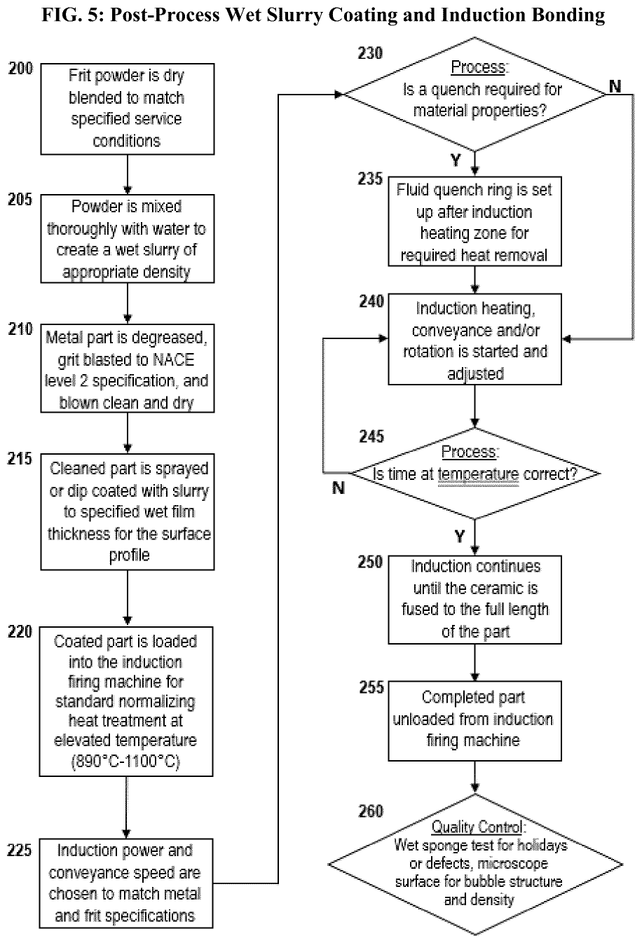

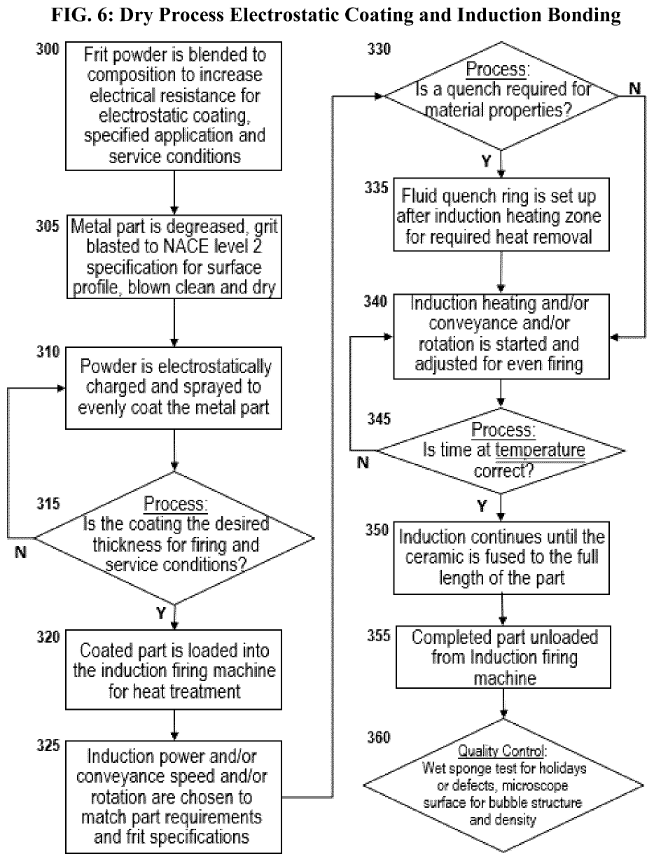

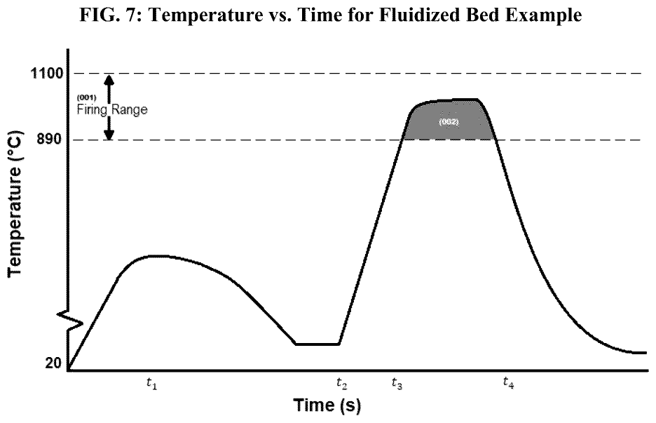

Now referring to FIGS. 4 and 5, a temperature-time plot of the heat schedule in relation to post-process induction bonding process is explained. For this example, a seamless pipe is grit blasted and internally coated prior to its normalizing step. Commonly, seamless pipe is heated and normalized briefly around a temperature of 925±25 °C (1700±75 °F) which coincides with the higher firing temperature range (001) and time of the ceramic coating. Normalizing and coating maturation, or heat work (002), occurs simultaneously between times t₁ and t₂. For this example, when the temperature cools to the transformation temperature of the steel at time t₃, it is further cooled in still air. However, a variety of quench methods could be utilized at t₃ for desired properties. Now with added reference to FIG. 6, an electrostatic coating and induction firing will follow a heat schedule with a temperature-time plot like FIG. 4. The metal part will be grit blasted and coated with a formulation of electrostatically charged ceramic powder. After the part is coated, it will be fired in the same manner as the seamless pipe in the prior example. Similarly, differing rates of cooling can be used depending on the service application and requirements of the part.

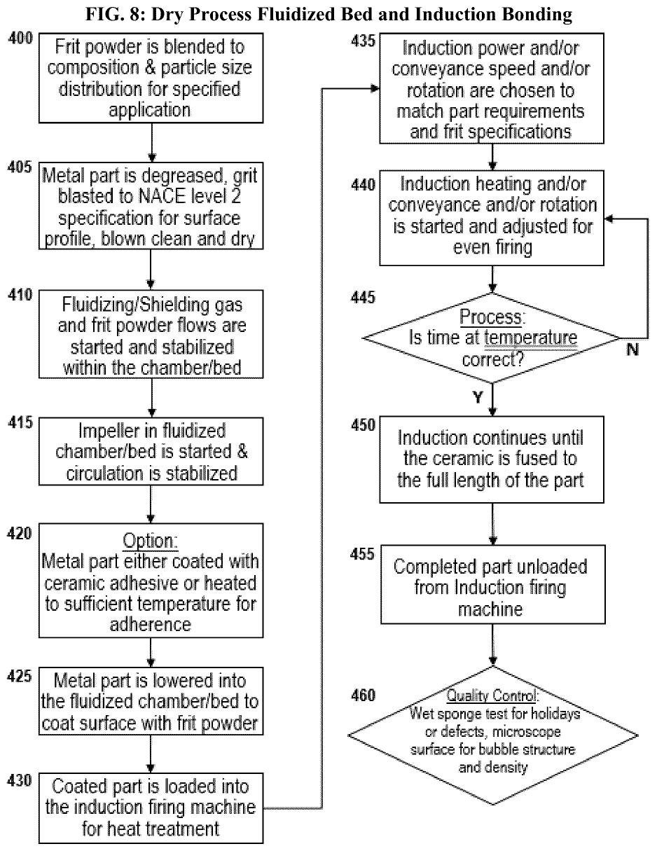

Referring to FIGS. 7 and 8, a temperature-time plot of a possible heat schedule for fluidized bed and induction bonding is shown. Multiple methods could be used for adherence of fluidized powder to a metal part. One of these methods includes heating the part to an elevated temperature, shown at time t₁, and lowering the part in the fluidized bed allowing for complete coverage before removing. Following this, or if another method of adherence not involving elevated temperature is used, the coated part is heated via induction at t₂. Within the firing range (001), the ceramic coating is matured and bonded to the part between times t₃ and t₄ utilizing heat work in the shaded region (002). As with previous examples, the firing temperature and time, as well as method and rate of heat removal after t₄ can each be adjusted based on the service conditions and mechanical property requirements of the part.

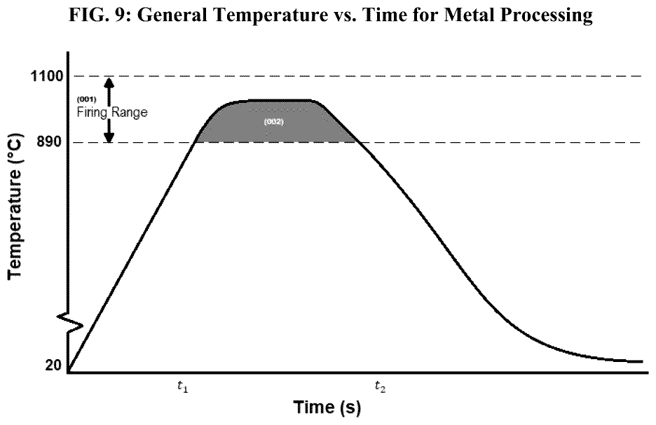

Referring to FIG. 9, a general temperature-time plot for heat treating a metal part coated with ceramic is described. Like in FIG. 1, the general plot for steel, the temperature of the coated metal part is increased into the firing range (001) of 890 °C to 1100 °C [1630 °F to 2010 °F] at time t₁. Heat work is the area under the plot (002) with a lower bound of minimum firing temperature between times t₁ and t₂. Adjustments to the firing temperature and firing time can be made to maintain the heat work. Depending on the type of metal coated and the service application, a variety of quench methods may be used after time t₂ to achieve desired mechanical properties.

These are examples of some of the heating schedules for the invention. While the modified ceramic coatings have a required heat input related to the heat work described in these examples, there is no single heat treatment which is best for all parts or applications. A variety of heating and cooling schedules may be utilized depending on desired metallurgical properties and chemistry or composition of the substrate to cover a wide range of applications. The primary focus of the innovation is the performance capabilities of the coating and unique firing temperature range in tandem with the processing steps that may follow.

### Processing Systems

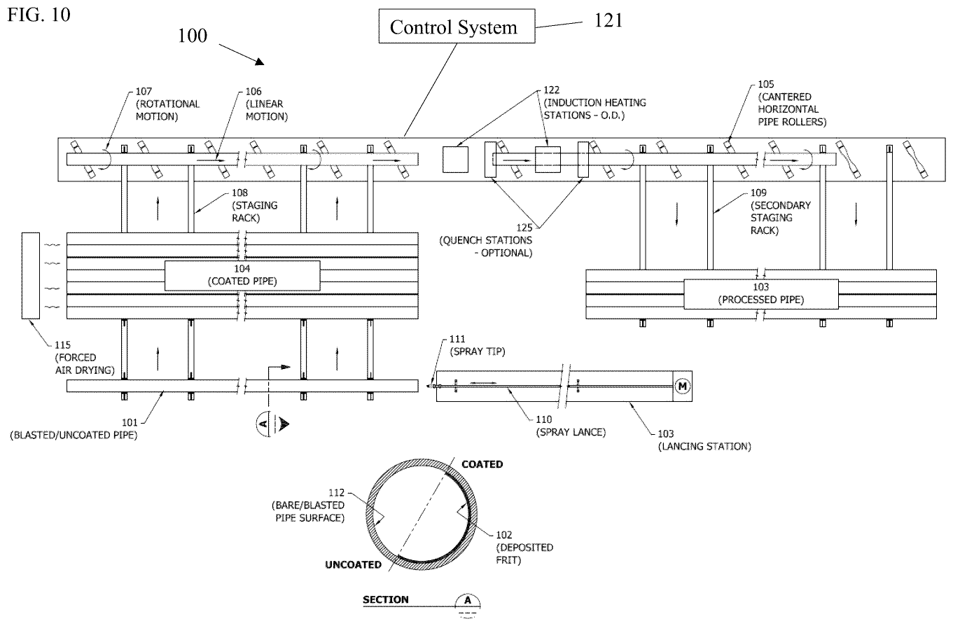

With reference to FIG. 10, in a non-limiting embodiment a processing system 100 for depositing the frit as a liquid slurry on the surface of the pipe will be described. Previously cleaned and prepared pipe 101 is shown at the lancing station 103. An internal spray lance 110 sprays the frit slurry from the spray tip 111 to the target area of the pipe surface 112 resulting in deposited frit 102. Forced air drying 115 is applied to the deposited frit 102 to create dried bisque. Dry coated pipe 104 is transferred to staging rack 108 which is forwarded onto roller conveyor 105 which provides both longitudinal motion 106 simultaneous with rotational motion 107 through induction heat station(s) 122. A control system 121 including suitable computer hardware and software controls the processing system 100 to process the pipes according to the afore-described treatment schedules for applying the ceramic coating to the pipes. Final processed pipe 113 is shifted from roller conveyor 105 to secondary staging rack 109.

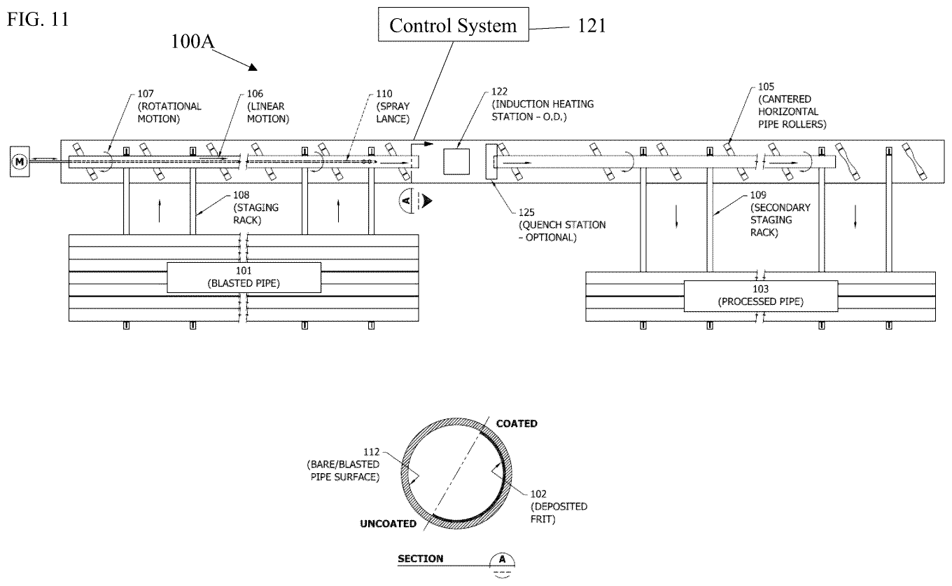

Referring to FIG. 11, in another non-limiting embodiment of a processing system 100A for depositing cold dry frit powder onto the target surface of the pipe 112 is described. Previously cleaned and prepared pipe 101 is shown on a roller conveyor 105 which provides both longitudinal motion 106 simultaneous with rotational motion 107. An internal powder spray lance 110 uses electrostatic charge to efficiently transfer the previously gas fluidized frit powder from the spray tip 111 to the target area of the pipe surface 112 resulting in deposited frit 102. Simultaneously, pipe is conveyed through induction heating station(s) 122 and processed.

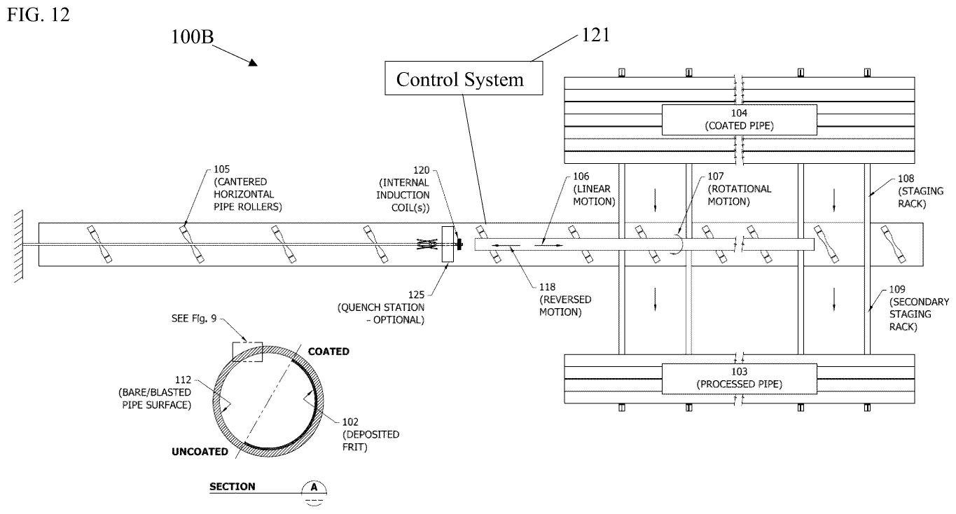

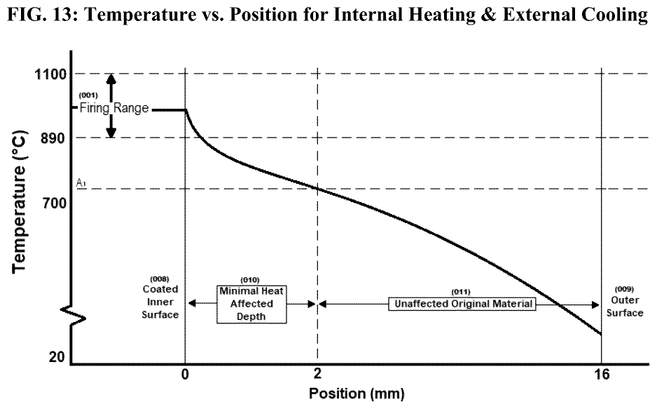

Now referring to FIG. 12, another non-limiting embodiment of the fully integrated thermal process system 100B is shown. Previously cleaned, prepared, and coated pipe 104 is forwarded from staging rack 108 with the deposited frit 102 onto a roller conveyor 105. Coated pipe 104 is reversed 118 into stationary internal induction coil(s) 120 which heats the inside surface of the pipe to the fusing temperature as the pipe moves longitudinally 106 and rotates 107 in conveyor 105. Externally mounted fluid cooling ring(s) 125 limits through-thickness heat transfer to ensure that only the inner surface of the pipe wall, to a specified minimal heat affected depth, exceeds the transformation temperature A1 of the steel for the coated pipe. This process may be modified to have external heating and internal cooling or some combination while following the same premise. With added reference to FIG. 13 temperature versus depth of transformation is described.

FIG. 13 depicts temperature versus depth for the fully integrated thermal process and system as described in reference to FIG. 12. The coated inner surface (008) is internally heated to the firing range (001) to fully process the vitreous ceramic. External cooling is applied to the outer surface (009) to limit the heating depth resulting in two distinct regions across the thickness of the material. A minimally heat affected depth (010) exists where the material was heated above the transformation temperature, A1. Unaffected original material (011) will comprise most of the thickness where the material remains below A1, the transformation temperature.

### Process-Specific Control Examples of Invention

The first example describes post-production coating and processing of a seamless pipe. After production, seamless pipe is normalized briefly around a temperature of 925±25 °C (~1700±75 °F) to reduce internal stresses. This temperature coincides with the higher firing temperature of the modified vitreous-ceramic coating described. Consequently, a seamless pipe with its inside surface grit-blasted and coated with vitreous-ceramic composite can be induction processed to mature the coating at the same normalizing temperature and cooled in still-air. Translation rate and heating band width are controlled such that the coating can fully activate and mature. The result is a pipe with a corrosion and hydrogen resilient inner layer of high-performance vitreous-ceramic coating without sacrificing the strength or toughness of the pipe. Increases in mechanical properties of the material have been exhibited multiple times for seamless pipes processed with this heating schedule.

Example two highlights a heating schedule associated with pre-processing coating of a seamed, electric resistance welded (ERW) pipe. After the weld is formed the seamed pipes are quench hardened with a high volume of water at a specific, controlled rate of heat removal for desired microstructure. Prior to a normalizing step to relieve stresses, the pipe would be grit blasted and internally covered with modified vitreous-ceramic coating. The coated pipe is heated to temperature, firing the coating; wide heating bands from the induction line permit faster feed speeds due to the rapid maturation of the vitreous-ceramic coating. This entire process is performed at a high rate of conveyance which yields an enhanced rate of production and throughput.

### Process Parameters Example 1: Back Side Heating

A seamless, 6.4 m (21 ft) long, 200 mm (8 in.) nominal diameter, 8.18 mm (0.322 in.) wall thickness standard carbon steel pipe of ASTM A333/Grade 359 Category II is initially grit blasted to achieve a NACE level 2 blast specification. It is then coated internally with a 20-mil (0.50 mm) thick wet layer of the vitreous-ceramic slurry. Once the coating has dried, the pipe is rapidly heated in dry air to 910 °C (1670 °F) via induction of 20 kHz and power input of 43 kW. The pipe is rotated at 9 RPM for even heating and is conveyed at linear rate of 42 mm/min. Heat transfer occurs in still air at an approximate cooling rate of 15 °C/min (59 °F/min). Final coating will have minimum thickness of 12 mils (0.30 mm).

### Example 2: Front Side Heating, Back Side Quench

A seamless, 2.3 m (7.5 ft) long, 200 mm (8 in.) nominal diameter, 8.18 mm (0.322 in.) wall thickness standard carbon steel pipe of ASTM A333/Grade 359 Category II is initially grit blasted to achieve a NACE level 2 blast specification. It is then coated internally with a 20-mil (0.50 mm) thick wet layer of the vitreous-ceramic slurry. Once the coating has dried, the pipe is rapidly heated using front side heating to 910 °C (1670 °F) via induction power input of 108 kW. Back side quenching with cold water of intake temperature 11 °C (52 °F) is applied simultaneously at a volume of 227 L/min to ensure transformation does not occur past a depth of 6.35 mm (0.25 in.). The pipe is rotated at 9 RPM for even heating/heat removal and is conveyed at linear rate of 41 mm/min. Heat transfer occurs at an approximate cooling rate of 150 °C/s (302 °F/s) resulting in an output water stream of temperature 27 °C (81 °F). Final coating will have minimum thickness of 12 mils (0.30 mm).

### Processing Ranges

Firing temperature: 890-1100 °C (1630-2010 °F);
Induction Frequency: 0.06-100 kHz;
Power Input: 1-1500 kW per unit;
Conveyance Rate: 10-10000 mm/min;
Rotation: 0-60 RPM;
Cooling Rate: 0.05-275 °C/s (32-530 °F/s);
Coolant Volume: 0-1000 L/s;
Coating Wet thickness: 12-60 mils (0.31-1.52 mm);
Coating Fired thickness: 10-50 mils (0.25-1.27 mm);
Multiple induction machines may be used to scale up power input and conveyance rate for optimal firing; and
Conveyance and rotation can be controlled by canted roller angle/position.

The invention has been shown and described in what is considered non-limiting embodiments. It is recognized that departures may be made within the scope of the invention and that modifications will occur to a person skilled in the art. With respect to the above description then, it is to be realized that the optimum dimensional relationships for the parts of the invention, to include variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed is:

1. A method of thermal processing a steel pipe and firing a vitreous-ceramic coating on the steel pipe while not causing loss of metallurgical properties of the steel pipe by the alpha to gamma phase change upon heat up and cooling, the method comprising:
providing a steel pipe having a ceramic frit applied and cured on a surface of the steel pipe;
with an inductive heating element, applying heat to the surface of the steel pipe as the inductive heating element moves along the surface of the steel pipe at a controlled rate;
with the inductive heating element, rapidly and controllably raising the temperature of the surface of the steel pipe to above a temperature of 890 °C and within a firing range of the frit for a period of time required to fire the frit.

2. The method of claim 1 wherein the step of rapidly and controllably raising the temperature of the surface of the steel pipe to above a temperature of 890 °C does not exceed the critical transformation temperature of the steel pipe throughout the thickness of the steel pipe.
